(19) United States
(12) Patent Application Publication
(10) Pub. No.: US 2023/0173461 A1
(43) Pub. Date: Jun. 8, 2023

(54) Mixtures of Binder Particles Used in Production of Immobilized Particulate Products

(71) Applicant: Koslow Technologies Corporation, Waterbury, CT (US)

(72) Inventor: Evan E. Koslow, Waterbury, CT (US)

(21) Appl. No.: 18/063,126

(22) Filed: Dec. 8, 2022

Related U.S. Application Data
(60) Provisional application No. 63/265,111, filed on Dec. 8, 2021.

(51) Int. Cl. B01J 21/18; B01J 31/06; B01J 35/02; B01J 37/04; B01J 37/00; C02F 1/28; C02F 1/70

(52) U.S. Cl. CPC B01J 21/18; B01J 31/06; B01J 35/026; B01J 37/04; B01J 37/0018; C02F 1/283; C02F 1/70; B01J 2531/002; B01J 2231/005; C02F 2101/12

(57) ABSTRACT

A carbon structure comprising a mixture and a polymer. The mixture has a base carbon and a catalytic carbon. The polymer has a first binder with a median diameter of less than 10 microns and a second binder with a median diameter between 10 and 70 microns.

### CROSS-REFERENCE TO RELATED APPLICATIONS

This patent application claims the benefit, under 35 U.S.C. § 119(e), of U.S. Provisional Application Ser. No. 63/265,111, filed on Dec. 8, 2021, the contents of which are incorporated herein by reference in its entirety.

### TECHNICAL FIELD

The present teachings relate to binder particles and binder particles used to produce immobilized particulate products.

### BACKGROUND

A wide range of products are produced where particulate materials are immobilized into sheets, tubes, profiles, and molded shapes. The particulate materials can be granular or fine powders and can be immobilized into structures through molding or extrusion processes. Carbon blocks are commonly used in water filtration applications to assist with taste and odor and, importantly, to filter impurities.

Structures such as carbon blocks help remove harmful contaminants. Activated carbon blocks remove contaminants and impurities by absorbing them from the water. Activated carbon has a high surface area of activated carbon and contains many tiny pores that can trap particles. Prior art examples of producing structures like carbon blocks include molding and extrusion of activated carbon, often with other active ingredients. Other examples include the formation of sheets of materials.

In all these cases, the active ingredient particles are blended with a binder consisting of a thermoplastic powder but potentially composed of a thermosetting powder or a low-temperature melting material that melts below the melting point of the active ingredient particles. Thermoplastic denotes substances that become plastic on heating and then harden on cooling. The particulate can be trapped via reaction and then trapped to immobilize the material.

In many cases, the presence of the binder particles significantly negatively impacts the performance of the active ingredients after being used to capture and immobilize the active ingredient. For example, the activated carbon and metal adsorbent powders used in carbon block water filters are significantly reduced in adsorptive capacity and kinetics of adsorption when bonded with standard powdered polyethylene binders. This problem can be called the “fouling” of the active ingredients. An adsorbent denotes chemical absorption that may occur when a substance is caught in nanopores or the surface of a substrate by low-energy electrostatic forces that attract neutral molecules to one another. Adsorbent capacity is essential for carbon block water filters.

To mitigate damage caused by fouling, using ultra-high molecular weight polyethylene (UHMWPE) binders to reduce the flow of the binder into the active ingredients could be beneficial. However, such binders present several problems. UHMWPE binders form bonds slowly and require extended processing time; this can cause reduced production capabilities. UHMWPE binders must also be used in high concentrations because they are often composed of larger particles that have difficulty fully capturing the active ingredients and preventing migration. Because these binders are used in high concentrations, they can physically displace active ingredients, reducing the final product's performance. This is referred to as the “displacement” of the ingredients. The problems of fouling and displacement result in products of reduced performance.

Fouling and displacement are especially prevalent when immobilizing activated carbons having enhanced catalytic activity. The use of activated carbon to catalytically degrade chloramines and reduce hydrogen sulfide in water is well known. Catalytic carbon enhances carbon's natural ability to change specific contaminants and promote chemical reactions as a catalyst. It has been shown that fouling of some catalytic carbons can reach up to 85% when using standard thermoplastic binders and that significant performance losses are observed even when using UHMWPE binders. Certain polyvinylidene difluoride (PVDF) polymers can mitigate this problem, but such binders would be much more expensive than those routinely used to produce carbon block products.

Thus, there is a need for binder particles that overcome the above problems experienced that have been described.

### SUMMARY

The present embodiments address the needs set forth herein and other needs and advantages, which illustrate the solutions and advantages described below.

It is an object of the present teachings to remedy the above drawbacks and shortcomings associated with known binder particles.

It is an object of the present teachings to provide binder particles that do not negatively impact—or minimize negative impact—on the performance of active ingredients, for example, active ingredients used in carbon block products.

To reduce the impact of polymeric binders on ingredients used in carbon block products, “polymer alloys” can be used consisting of a small amount of ultra-fine polymer particles blended with a more conventional binder. In this system, the ultra-fine particles can be caused to attach to the very fine active ingredient particles within a formulation, while the generally larger polymer particles can bond to the larger particles within the system. In this manner, the overall amount of polymer binder required to immobilize all the particles in the system fully can be significantly reduced.

For example, if the typical amount of UHMWPE binder used in carbon block products is 25-40% by weight and the smaller low-density polyethylene binder might be 15-18% by weight, the new polymer alloys can be successfully used within the 6-12% by weight range. In addition, the fouling of sensitive catalytic carbon can be reduced from 30-85% when using standard thermoplastic binders down to 15-35%, depending upon the exact choice of catalytic carbon and polymer alloy.

Other features and aspects of the present teachings will become apparent from the following detailed description, taken in conjunction with the accompanying drawings, which illustrate by way of test results the features in accordance with the present teachings. The summary is not intended to limit the scope of the present teachings.

### BRIEF DESCRIPTION OF THE DRAWINGS

FIG. 1 illustrates an insulated thermos reactor with a Styrofoam cup seal. A glass funnel is placed inside the cup, and a digital thermometer extends into the fluid within the cup. The method and apparatus are adapted from Calgon Carbon.

FIG. 2 is a test result of the Catalytic Activity of Non-Catalytic Carbons.

FIG. 3 is a test result of the Catalytic Activity of Catalytic Carbons.

FIG. 4 is a test result of the Catalytic Activity of a Mixture of Catalytic Carbon and Base Carbon without a binder.

FIG. 5 is a test result of a mixture of Catalytic Carbon and Base Carbon and a binder GUR 2105-01 at 14% by weight of the mixture.

FIG. 6 is a test result of a mixture of Catalytic Carbon and Base Carbon and a binder GUR 2105-1 at 16% by weight of the mixture.

FIG. 7 is a test result of a mixture of Catalytic Carbon and Base Carbon and a Nylon-12 binder at 6% by weight of the mixture.

FIG. 8 is a test result of a mixture of Catalytic Carbon and Base Carbon and a Nylon-12 binder at 8% by weight of the mixture.

FIG. 9 is a test result of a mixture of Catalytic Carbon and Base Carbon and an HDPE binder at 14% by weight of the mixture.

FIG. 10 is a test result of a mixture of Catalytic Carbon and Base Carbon and an HDPE binder at 12% by weight of the mixture.

FIG. 11 is a test result of a mixture of Catalytic Carbon and Base Carbon and a MMWPE binder at 14% by weight of the mixture.

FIG. 12 is a test result of a mixture of Catalytic Carbon and Base Carbon and a first binder Nylon-12 at 3% by weight of the mixture and a second binder MMWPE at 6% by weight of the mixture.

FIG. 13 is a test result of a mixture of Catalytic Carbon and Base Carbon and a first binder Nylon-12 at 3% by weight of the mixture and a second binder GUR at 5% by weight of the mixture.

FIG. 14 is a test result of a mixture of Catalytic Carbon and Base Carbon and a first binder Nylon-12 at 2% by weight of the mixture and a second binder MMWPE at 6% by weight of the mixture.

### DETAILED DESCRIPTION

The present teachings are described more fully hereinafter with reference to the accompanying drawings, in which the present embodiments are shown. The following description is presented for illustrative purposes only, and the present teachings should not be limited to these embodiments.

The present teachings have been described in language more or less specific as to structural and mechanical features. However, it is to be understood that the present teachings are not limited to the specific features shown and described since the disclosed comprises preferred forms of putting the present teachings into effect.

For purposes of explanation and not limitation, specific details are set forth, such as particular structures, architectures, interfaces, techniques, etc., to provide a thorough understanding. In other instances, detailed descriptions of well-known devices and methods are omitted so as not to obscure the description with unnecessary detail.

Generally, all terms used in the claims are interpreted according to their ordinary meaning in the technical field unless explicitly defined otherwise. All references to a/an/the element, apparatus, component, means, step, etc., are to be interpreted openly as referring to at least one instance of the element, apparatus, component, means, step, etc., unless explicitly stated otherwise. The steps of any method disclosed herein can be performed in any order unless explicitly stated. The use of “first”, “second,” etc. for different features/components of the present disclosure is intended to distinguish the features/components from other similar features/components and not to impart any order or hierarchy to the features/components.

Carbon block technology depends on conventional activated carbons, which provide the adsorptive capacity against particulate materials. As described, activated carbon is immobilized into a carbon block through molding, extrusion, or the formation of sheets of materials. The carbon block enhances the kinetics, or speed, of the adsorption process. A typical consumer water filter may have a contact time of only 3-to-12 seconds with the activated carbon. This compares to conventional beds of activated carbon used in municipal applications where contact times can typically be 1,000-to-4,000 seconds, equating to more than an hour of contact time.

The purpose of a carbon block filter is to accomplish a comprehensive purification of water in a timeframe perhaps 100-to-1,000 times faster than in a traditional activated carbon application. The carbon is essentially the same in both applications; the kinetics are enhanced using carbon block technology.

Activated carbon remains the primary material used in point-of-use/point-of-entry (POU/POE) water treatment devices to control chlorine, taste, and odor. The advantage of activated carbon is its broad-spectrum capacity to adsorb organic chemicals and promote catalytic/chemical reduction of chlorine disinfectants.

Powdered catalytic activated carbons are among the few options demonstrating enhanced catalytic performance. For the described kinematic advantages, powdered carbons must be converted to carbon blocks. Users are trapped between the need to use powdered carbons and the significant issues of converting these powders into a block without severe loss of activated catalytic carbon, fouling, or displacement. The catalytic activity must be preserved without waste, especially because activated catalytic carbon is significantly more expensive than conventional activated carbon.

First, determining the catalytic activity of non-catalytic and catalytic carbons to determine a baseline of catalytic activity before the addition of the polymer thermoplastic binder is needed. The testing of thermoplastic binders within the mixture of catalytic carbon, base carbon, and then the addition of the thermoplastic binder by weight of the mixture is also required to determine the loss of catalytic activity resulting from the thermoplastic binder. Therefore, this testing allows for determining polymer alloys that may be used to reduce the issues discussed.

As used herein, the term “polymer alloy” does not mean that the two polymers are caused to be melted together. The two binders are not fused. A specific mixture or combination of polymer particles has been used in the case a polymer alloy is used. This mixture consists of a particle of fewer than 10 microns in median diameter and a polymer particle size of 10-70 microns.

The two polymer particles can be composed of the same polymer base material (LDPE, MMWPE HDPE, NYLON, GUR) or two entirely different polymers. HDPE refers to high-density polyethylene, MMWPE refers to middle molecular weight polyethylene, and GUR refers to ultra-high molecular weight polyethylene. This mixture may have a “bimodal” particle size distribution when comprising a single-base binder polymer. When the mix consists of two entirely different binder polymers, Applicant uses the term “polymer alloy.”

A micron rating for a fluid filter is a generalized way of indicating the ability of the filter to remove contaminants by the size of the particles. For example, a nominal micron rating of 10 microns at 95% means that the filter media retains 95% of the particles that are 10 microns and larger. When the carbon block is primarily composed of larger particles, as in the case of “CTO” filter elements with a 10-micron filter rating, the amount of binder may be 2-3% by weight of the smaller particle and 5-6% of the larger particle.

The micron filter rating may also be less than a 10-micron filter rating. If the carbon block product is composed of a high percentage of fine particles, the binder amount may rise to 3-5% of the smaller particles and around 8-10% of the larger particles.

The amount by weight of smaller particles within the binder mixture may be lower than the weight of particles of larger size. A typical ratio of smaller to larger particle weights may be 2:5, 3:6, or 3:8, for example.

The increasing amount of polymer binder occurs because of the statistical particle packing of the active ingredient and binder particles. As the superficial surface area of the active ingredients increases, an increased amount of binder is required to hold the structure together. However, in all cases, the amount of binder is significantly reduced compared to that needed for standard thermoplastic binders.

An approach to resolving the issues discussed is using a binder composed of ultra-small binder particles. Ultra-small binder particles are binders that are low in microns, such as the 6-micron Nylon-12. However, such ultra-fine polymers are exceedingly expensive, and it has been found that using pure ultra-fine binders often causes more significant damage to catalytic carbons than the polymer alloys outlined herein. As demonstrated in the following figures, the use of pure ultra-fine binders and pure conventional binders both resulted in more significant losses of catalytic carbon activity than the use of the polymer alloys of the present invention.

A smaller amount of two polymers applied together to form a polymer alloy was superior to using a larger number of pure conventional polymers. This surprising result was shown to be true for essentially every polymer combination tested.

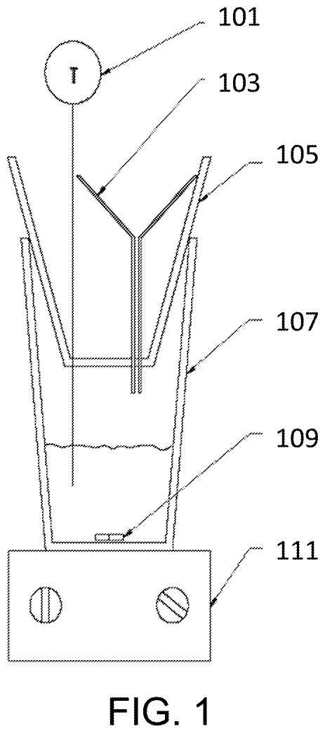

The apparatus shown in FIG. 1 is a method that is a derivative of that initially developed by Calgon Carbon was used (see U.S. Pat. No. 5,470,748 to Hayden et al.). The method is provided for evaluating the catalytic activity of carbon. The technique uses the decomposition of hydrogen peroxide in contact with carbon to measure the catalytic activity of the carbon. The catalytic peroxide degradation reaction may be used as a surrogate for chloramine and hydrogen sulfide reduction reactions.

In FIG. 1, a stainless steel, flat-bottom thermos cup may be placed onto a magnetic stirrer 111 for testing purposes. The cup may be sealed with an insulating Styrofoam cup 105 with three perforations. One perforation may allow the passage of a glass funnel 103 to admit chemicals into the reactor. The second perforation may be for a digital thermometer 101 to be immersed in the fluid within the reactor. The third perforation may be used to vent the reactor.

A measured amount of carbon sample was used. This sample was loaded onto a plastic weigh boat and measured on an analytical balance sensitive to 0.001 gram. It was introduced to the reactor directly (not through the funnel), and a 100-gram quantity of distilled water was loaded into the reactor to disperse the carbon. A 50-gram amount of buffer solution was then added to the reactor. This buffer consisted of 0.5 M potassium phosphate monobasic and 0.5 M potassium phosphate dibasic. The ingredients were brought to room temperature before their use. The contents of the reactor were allowed to stir (roughly 600 RPM) for several minutes with the magnetic stir bar 109 and stir speed selected to create a powerful vortex within the reactor with the central cone of fluid drawn down approximately 0.5 inches. The temperature was confirmed to be stable, and then it was recorded.

Once the carbon had a few minutes to be wet by the distilled water and buffer, 50 grams of 30 percent analytical-grade room-temperature hydrogen peroxide (no stabilizer) was added through the funnel. This immediately initiated the experimental timer, and the temperature was recorded at one-minute intervals. After a total of 10 minutes, the experiment was stopped. In this method, the rise in temperature occasioned by the decomposition of hydrogen peroxide under essentially adiabatic conditions is monitored as a function of time. By use of this method, carbon with high catalytic activities may be identified.

It has been previously demonstrated that the catalytic performance of raw catalytic carbon, which is the measure of the catalytic carbon by itself, is a partial measure of its performance. The performance also depends upon the ability of the carbon to resist fouling when mixed with suitable binders. Fouling occurs when the activated carbon and metal adsorbent powders used in carbon block water filters significantly reduce adsorptive capacity and kinetics adsorption when bonded with standard powdered polyethylene binders.

To study the ability of the selected carbons to resist fouling when mixed with suitable binders, measurements with samples that have passed through simulated carbon block production were carried out. Simulated carbon block production was conducted with samples of each carbon, and they were combined with varying quantities and types of thermoplastic binders.

There are different processes used for manufacturing a carbon block, known as extrusion, compression molding, and formation of sheets of materials. In the extrusion process, a mixture of carbon and polymeric binder is introduced to form a continuous porous block. Heat is applied to the mixture to make the binder melt. The blocks are then left to cool down and solidify. In the compression molding process, the same mix is used. The compressed carbon blocks are manufactured individually in a mold under pressure and high heat and then trimmed to size. Different amounts of porosity may be created by varying the carbon and binder mesh sizes.

The term mesh refers to the number of particles per unit scale; thus, the greater the mesh, the finer the granule, and the less porous the resulting combination of carbon and binder.

The activated carbon and binder may form any size mesh, but the carbon mesh used depends on the work for which the carbon block is intended. For the carbon blocks that need to be more porous, the carbon mesh may be between 40 and 210 mesh, for example, for sediment and removing chlorine, odor, and taste. The carbon blocks that need to be able to remove volatile organics and cysts the carbon block should be of lesser porosity. For this, the carbon powder mesh size is between 80 and 320 mesh, preferably between 190 and 320 mesh.

In a method for simulated carbon block production, five grams of each blended sample may be loaded into a 30-ml conical porcelain crucible and then compressed by inserting a second identical conical crucible to create a thin layer between the crucible surfaces. After that, it may be placed into a digital lab convection oven at 195° C. for 10 minutes. After heat processing, the samples cool in the laboratory atmosphere and are then crushed into a powder for an assay of catalytic activity.

To compare samples, it may be necessary to account for any variation in the amount of carbon in the sample and measure the slope of the temperature increase before a serious diminution of hydrogen peroxide within the reactor. To do this, one solves for catalytic activity (Ac) using the following equation:

Ac=(ΔT/dt)/q (1)

Where ΔT (° C.) is the change in temperature for time interval dt (minutes) and where q is the weight (grams) of carbon within the sample (minus the weight of any binder within the sample), the applicant selected the slope in the early portion of each measurement between the 1-3 minutes of reaction time (well within the linear portion of the reaction. It should be noted that the amount of peroxide used in this test is sufficient to cause a maximum temperature increase of approximately 52° C.

The carbon structure consists of a mixture of base and catalytic carbon. The base carbon composes 75-85% of the mixture by weight, and the catalytic carbon composes 15-25% by weight. The mixture contains a particular weight. The binder is added as a percentage by weight of the base and catalytic carbon mixture. Therefore, if Nylon-12 is added at 3% by weight of the mixture, an amount corresponding to 3% of the weight of the mixture is added of the Nylon-12 binder.

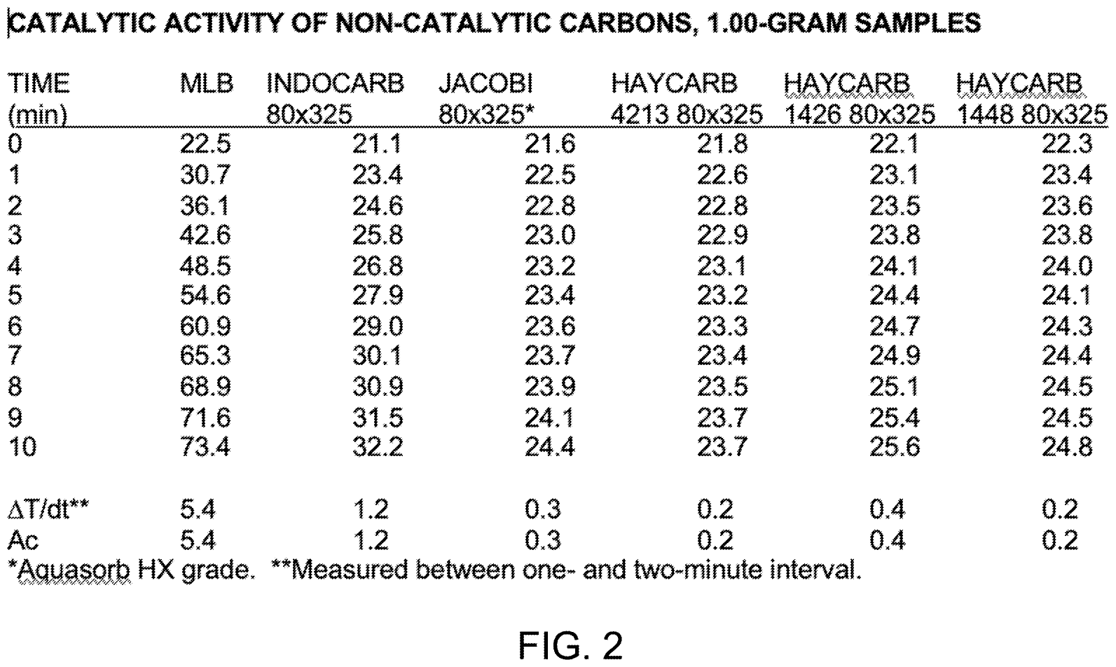

FIG. 2 shows non-catalytic carbons that may be chosen as the base carbon to form part of the mixture in the sample carbon blocks. In FIG. 2, the result of the measurements on non-catalytic carbons and the calculated Ac values for these carbons is determined. Particle size is one of the most important elements of obtaining the best possible performance from catalytic carbon. When feasible, the catalytic carbon within a product should be the smallest particles of carbon within the product, while conventional activated carbon should be the larger size fraction.

The measurements of non-catalytic carbons are carried out with a sample of 1.000 grams, and the catalytic carbons are measured using a sample of 0.200 grams. In the case of the M.L. Ball (MLB) carbon, both weights of the sample were used to observe if the value of Ac (catalytic activity) is the same under both conditions. The M.L. Ball Carbon resulted in the highest catalytic activity by a significant amount with an Ac of 5.4. Indocarb followed at an Ac of 1.2. It is important to understand the catalytic activity of the non-catalytic carbons to understand the base carbon's catalytic contribution in the carbon block formulation.

The non-catalytic carbons may also be known as base carbons. The base carbons may be microporous in internal structure, making them well-suited for organic chemical adsorption. The properties will help them to adsorb volatile organic chemicals while having higher chlorine reduction capabilities. Many organic compounds, such as chlorinated and non-chlorinated solvents, trihalomethanes, pesticides, and VOC, are adsorbed into the inner pores. For example, Indocarb is used in point-of-use and point-of-entry drinking water filtration devices to improve the quality of drinking water by removing unwanted compounds such as arsenic, chlorine, and chlorinated by-products such as THMs, chloramines, lead, and volatile organic compounds (VOC's). Indocarb may be selected because its pore structure may allow contaminants to be exposed significantly to adsorption sites in the carbon lattice. Indocarb may also be chosen because it is a cost-effective solution.

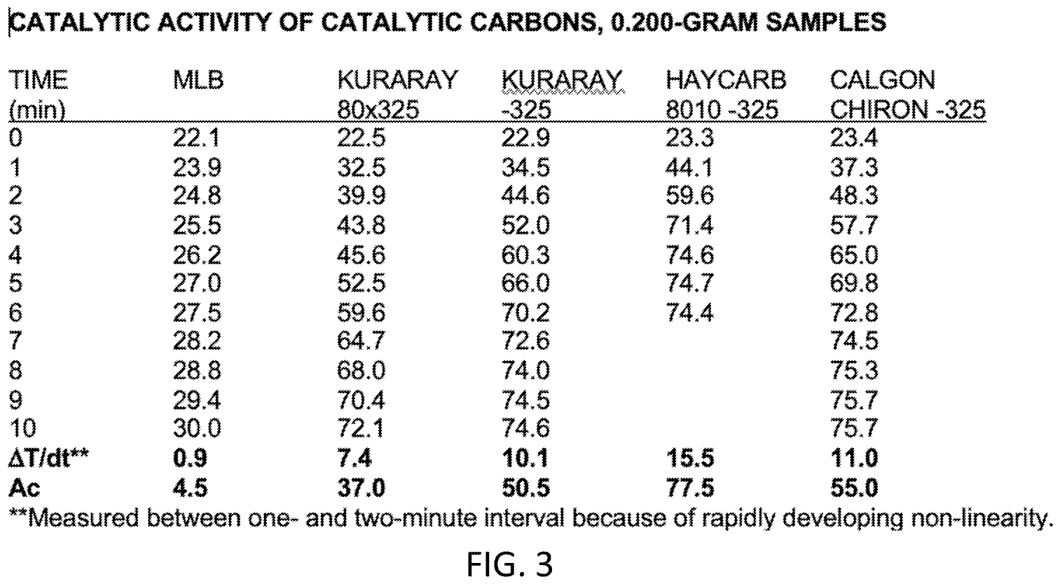

FIG. 3 produces a baseline of catalytic carbon performance and the second component of the mixture. As discussed, particle size is one of the essential elements of obtaining performance from catalytic carbon. Typically, as particle size declines, the speed of the catalytic reaction increases. Therefore, catalytic carbon may contain the smallest particles in a mixture.

In FIG. 3, catalytic carbon performance at 0.200-gram samples allows for determining the catalytic activity of the selected catalytic carbon before creating a mixture with a base carbon and then the added polymer binder. A catalytic carbon may be chosen as the catalytic carbon in the mix based at least on its catalytic performance. The HayCarb 8010 carbon sample's catalytic performance is nearly 50% greater than the closest catalytic carbon. The Calgon Chiron carbon displays performance very similar to that of the Kuraray-325 sample (Ac=55 and 50, respectively). The HayCarb may have superior inherent catalytic performance.

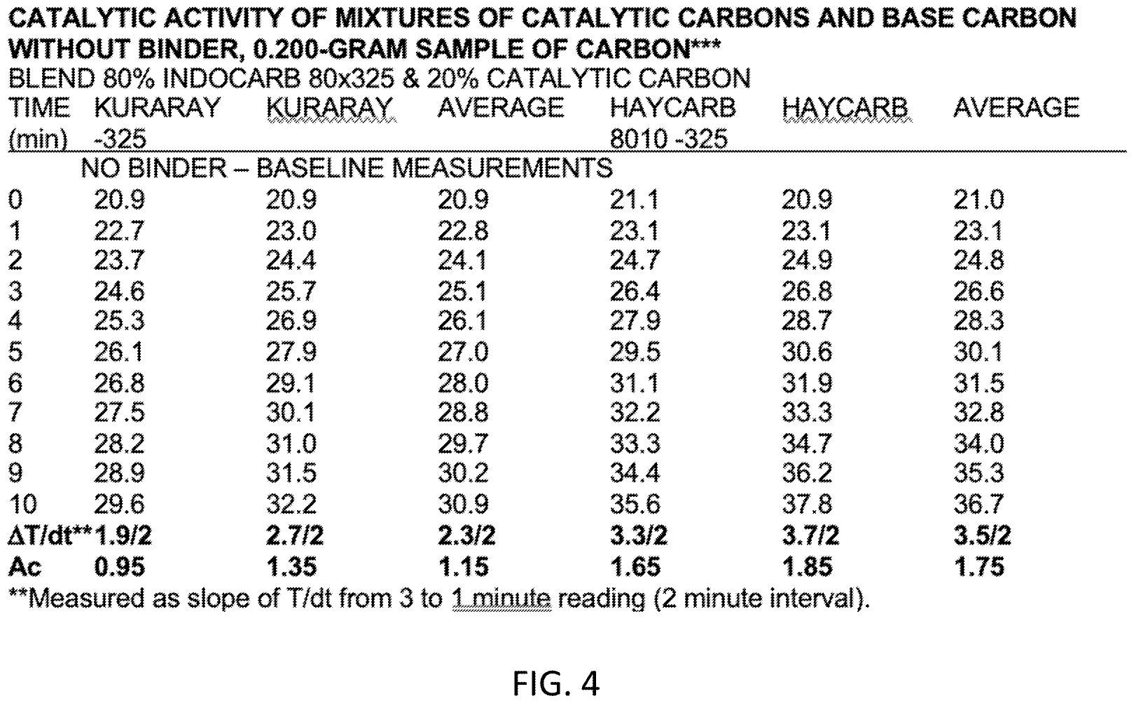

In FIG. 4, the measurements began with a formulation containing 20% by weight of either Kuraray-325 mesh or HayCarb 1810 blended with 80% by weight of IndoCarb 80×325 mesh carbon. Both catalytic carbons (Kuraray and HayCarb) were measured to determine the superior catalytic performance of the two when mixed with the IndoCarb base carbon. The average of two measurements was used as a benchmark for catalytic carbon performance that occurs before processing with the addition of a binder. The mixtures were then processed through an oven as if they contained a binder and ran a standard catalytic activity test. It is known that there may be no significant impact observed from the exclusive heating of a sample of catalytic carbon; this is generally true for all catalytic carbons.

In FIG. 4, the performance of Kuraray carbon is lower than that of the HayCarb material, which affirms the data shown in FIG. 3, where HayCarb has a 53.5% increased performance compared to Kuraray. HayCarb may contain particle size distributions that are more effective for catalyst dispersion over the carbon surface. HayCarb may inherently be the superior catalyst compared to the catalyst tested.

It has been previously demonstrated that the loss of catalytic activity of the activated catalytic carbon may not be the result of applying heat during the molding or extrusion of the powdered carbons into a carbon block. Instead, it appears to relate to the amount, type, and heating of the carbon in the presence of a thermoplastic binder.

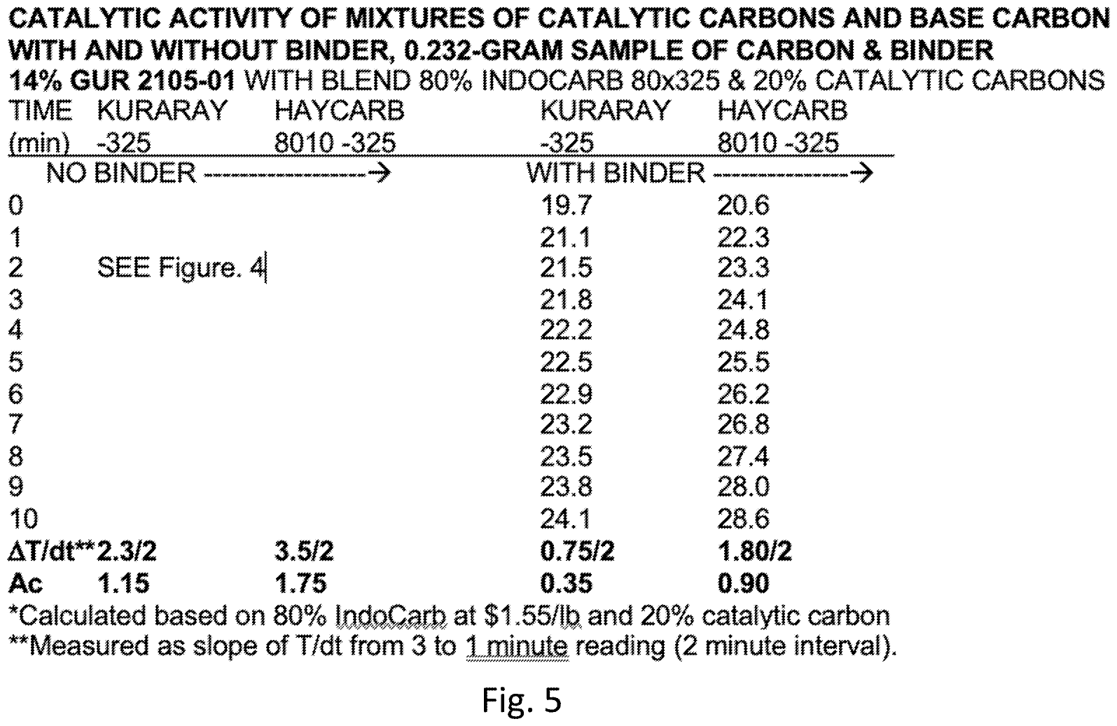

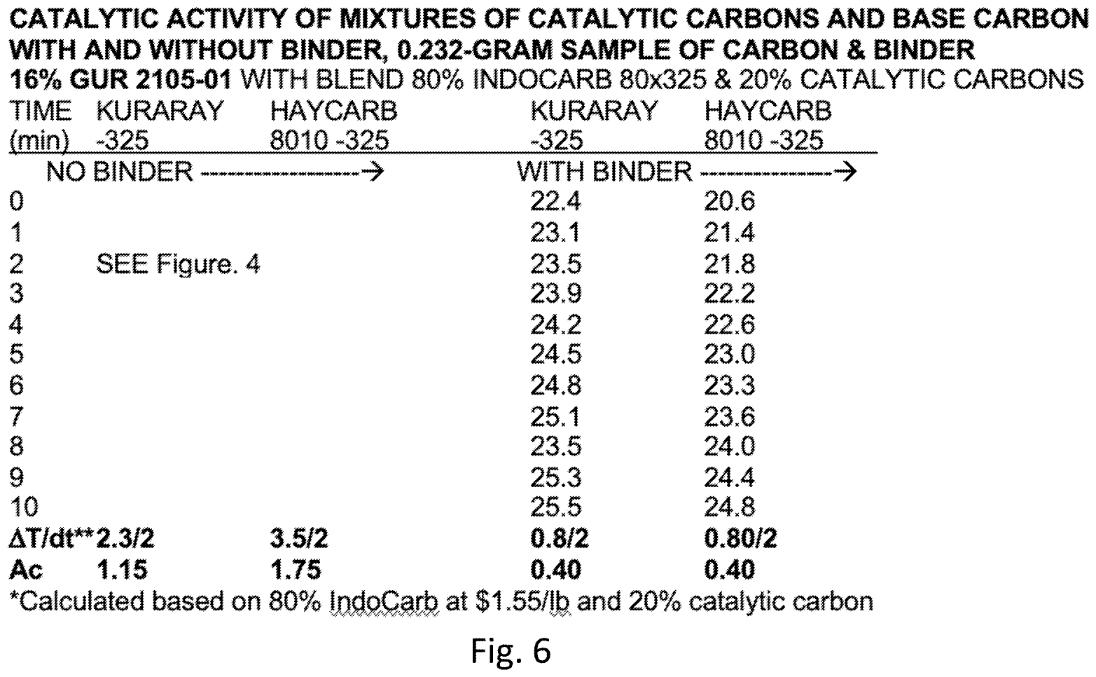

FIGS. 5 and 6 show the catalytic activity of the mixture with the addition of the polymer binder, GUR 2105-01 (GUR) at 14% by weight of the mixture. The mix of base and catalytic carbon was blended with a binder formulation representing the typical range of binders required to obtain structurally sound carbon blocks. Samples were heated to 195° C. (approximately 400° F.—an average process maximum temperature for a polyethylene resin). GUR is an ultra-low melt-flow index binder. The melt flow index measures the resistance to flow (viscosity) at a given temperature under a given force for a predetermined period. GUR is usually used in relatively high percentages (20 to 40 percent being the typical commercial range) to produce carbon blocks by molding. GUR 2105-1, as opposed to GUR 2126, is a high molecular weight polyethylene, not an ultra-high molecular weight polyethylene.

FIG. 5 provides the results of Catalytic Carbon, Base Carbon, and binder, GUR 2105-01 at 14% by weight. The 14% by weight of GUR 2105-01 is close to the minimum recommended amount by weight of this binder for use in the production of carbon blocks. HayCarb is vulnerable to processing with the GUR 2105-1 binder at 14% by weight of the mixture, with a significant decline in the performance of 46.6%. The Kuraray carbon is also sensitive to processing with the GUR 2105-1 binder at 14% by weight, with a decline in Ac of 31%. Both catalytic carbons were reduced in performance, but HayCarb 8010 remained the superior catalytic carbon.

FIG. 6 provides the results of Catalytic Carbon, Base Carbon, and binder, GUR 2105-01 at 16% by weight. The 16% GUR 2105-01 formulation produces a mechanically strong carbon block that is certain to be acceptable for use in consumer applications. These conditions caused a roughly 69.5% reduction in the catalytic performance of Kuraray-325 carbon and a 48.6% decline in HayCarb 8010 catalytic performance. The 16% GUR 2105-1 formulation destroys most of the catalytic properties of the carbon with HayCarb 1810, declining by 77.1%.

FIGS. 5 and 6 demonstrate that using an ultra-low melt-flow index polymer, like GUR, is insufficient to protect the catalytic carbon. The 16% GUR 2105-1 formulation creates a decline that renders the formulation unusable. This may be because the GUR binder is typically used in higher weight percentages. The loss in activity may also be caused by the displacement of carbon by the binder. As discussed, GUR is a low-melting binder, which melts at low temperatures and may bind with the carbon block. The low-melting binder may melt, flow, and cover the carbon surfaces. The available surface area of the carbon particles may be covered by the binder when the binder is allowed to melt and flow, making the carbon less efficient in adsorbing capacity.

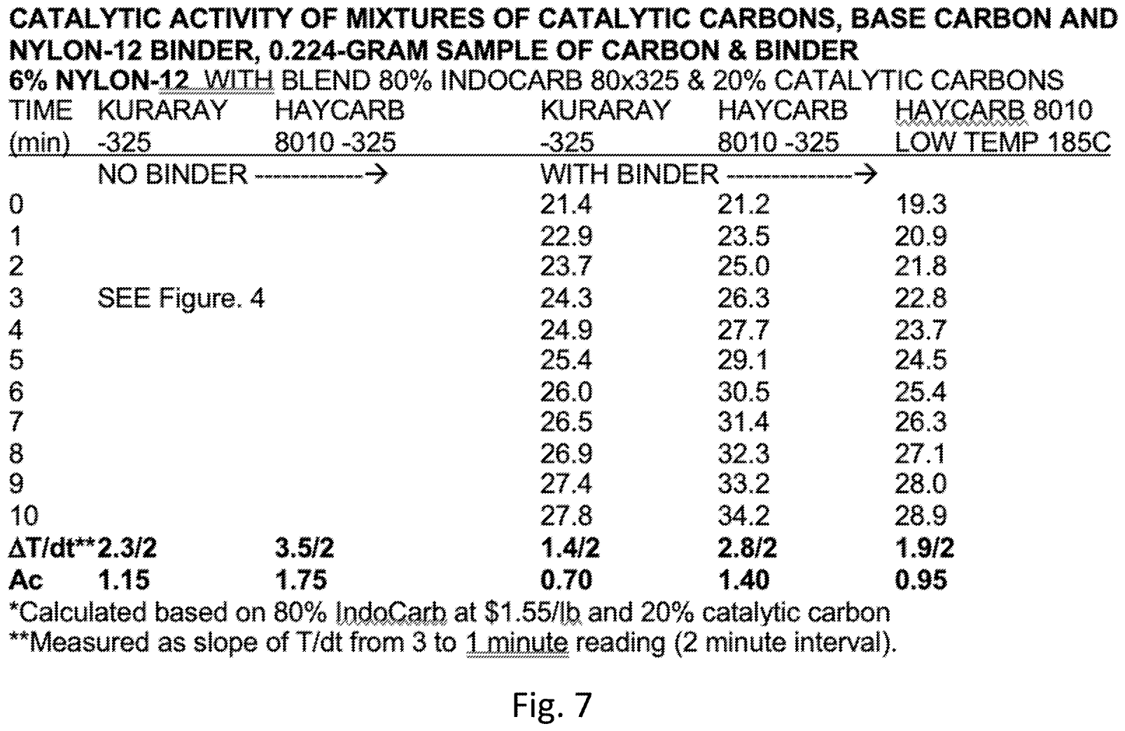

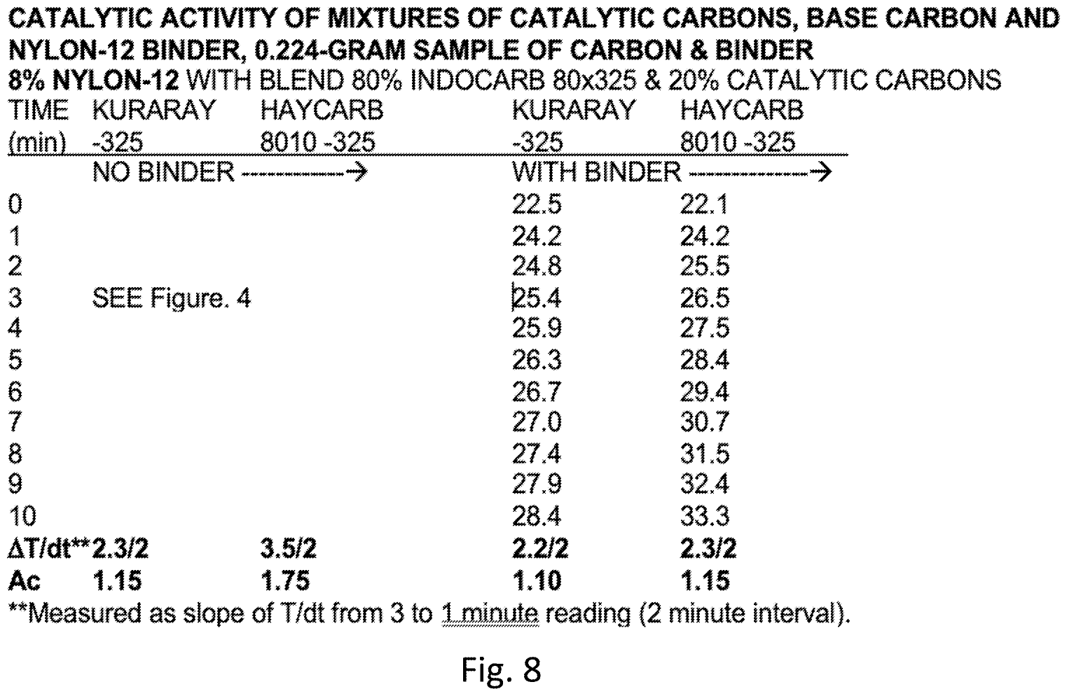

FIGS. 7 and 8 show the catalytic activity of the mixture with the polymer binder, Nylon-12. The mix of base and catalytic carbon was blended with the same technique. Nylon 12 is an ultra-fine thermoplastic binder composed of 6-micron particles, with 90% of such particles between 5-7 microns. Ultra-fine particles may attach to the other ultra-fine active ingredient particles meant to be captured within a formulation.

FIG. 7 provides the result of Catalytic Carbon, Base Carbon, and 6% by weight of the mixture of Nylon-12 binder. In FIG. 7, using 6%, Nylon-12 binder results in a loss of 20% activity for HayCarb and a 39.1% decline in activity for Kuraray. In this instance, HayCarb handles the binder exposure better than Kuraray in terms of catalytic performance. Still, the result was that the simulated carbon block emerging with this formulation is poorly bonded and easily crumbles. The catalytic powder could not bind sufficiently to create a solid carbon block.

FIG. 8 provides the result of Catalytic Carbon, Base Carbon, and 8% by weight of the mixture of Nylon-12 binder. In this test, the applicant found that the situation is reversed, and the Kuraray catalytic carbon shows only a 4.3% decline in performance, while the HayCarb 8010 shows a decline of 34.3%. The 8% Nylon-12 formulation provides a reasonably strong and stable carbon block.

The Nylon-12 formulation may deteriorate the catalytic activity of the Haycarb 8010 catalytic carbon and only mildly affects the catalytic activity of the Kuraray catalytic carbon. The Nylon-12 provides an ultra-fine binder that may offer a practical formulation. Regardless, finding a formulation that would be more effective for catalytic carbons, providing overall, more robust catalytic performance like HayCarb, is important. In addition, the single use of Nylon-12 may prove to be more cost prohibitive.

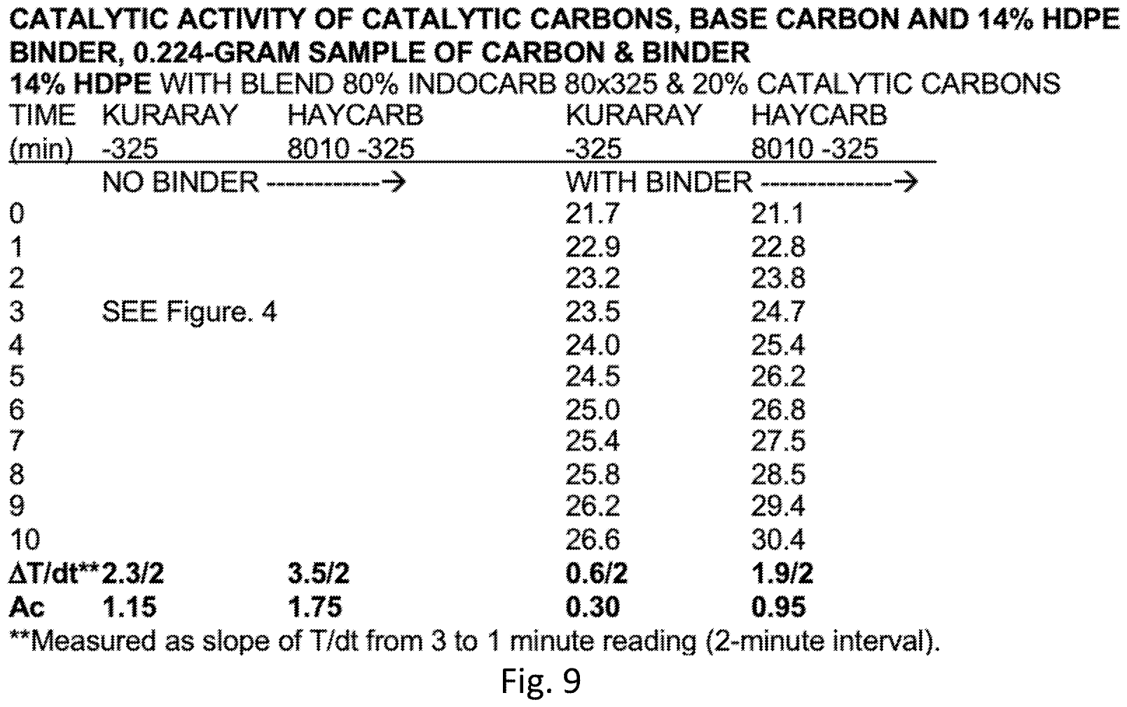

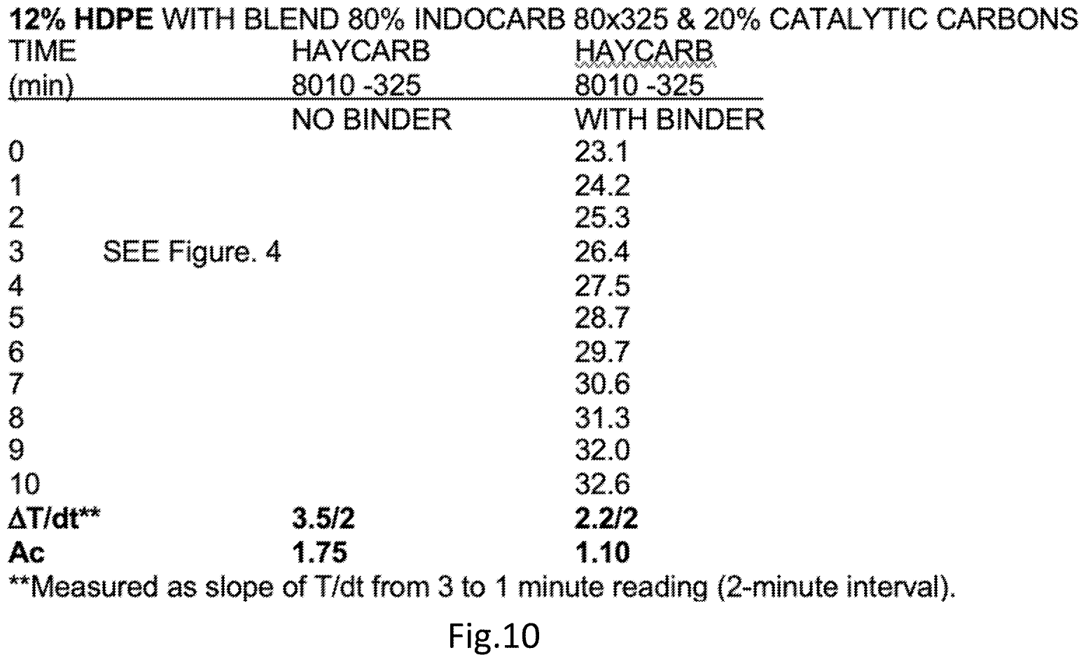

FIGS. 9 and 10 show the catalytic activity of the mixture with the addition of a binder, HDPE. The mix of base carbon and catalytic carbon was blended with the same technique. HDPE is a thermoplastic polymer produced from the monomer ethylene and is about 65 microns in size. The polymer is known for its high strength-to-density ratio.

FIG. 9 provides the result of Catalytic Carbon, Base Carbon, and 14% by weight of the mixture of HDPE. The results for the 14% formulation here are different from past measurements, with Kuraray-325 carbon experiencing a 73.9% reduction in catalytic activity and HayCarb 1810 experiencing a significantly less 45.7% decline in activity. The quality of the carbon block was excellent and indicated that it could reduce the binder further because less binder may be necessary to create a structurally sound carbon block with less damage to the catalytic carbon activity.

FIG. 10 shows Catalytic Carbon, Base Carbon, and 12% by weight of the mixture of HDPE. The only catalytic carbon used was HayCarb because of the significant reduction in catalytic activity seen with Kuraray. There was still a 37.1% decline in performance for HayCarb and the development of a much lower quality carbon block with poor mechanical properties.

FIGS. 9 and 10 show that using thermoplastic binders with a larger size, such as the approximately 65 microns in size binder HDPE by itself, may result in significantly decreased catalytic activity for both Kuraray and HayCarb. In addition, although a structurally sound carbon block may be produced with 14% HDPE, the damage to the catalytic carbon is still significant.

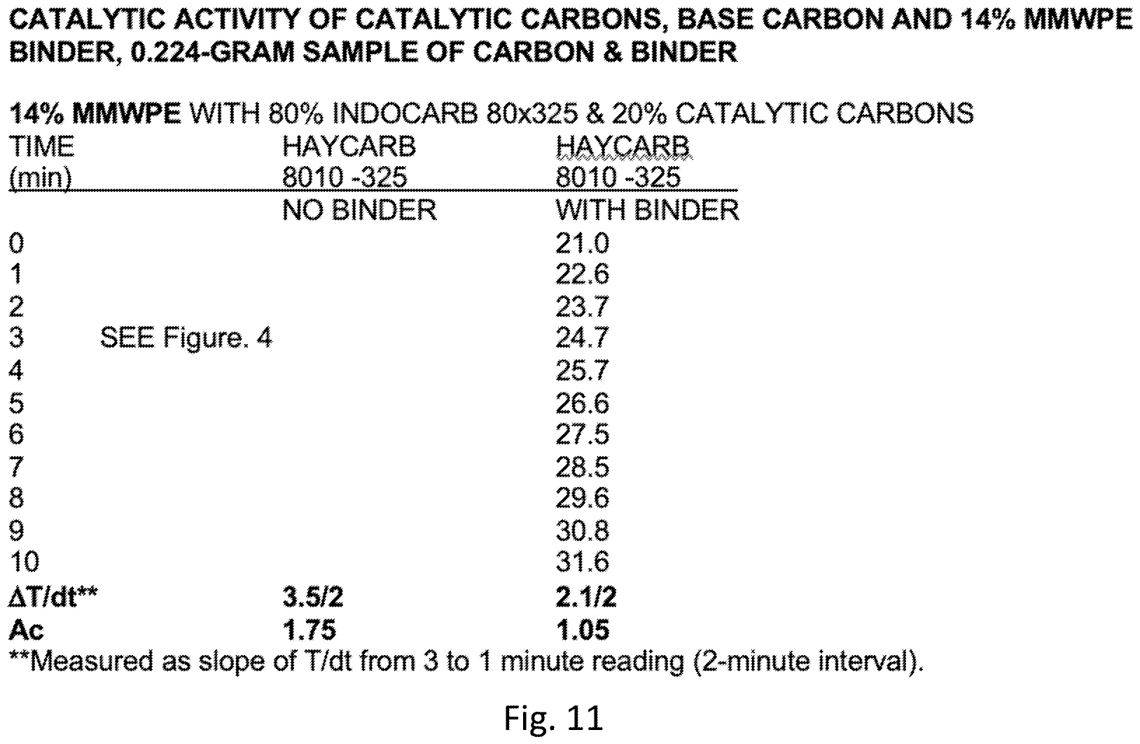

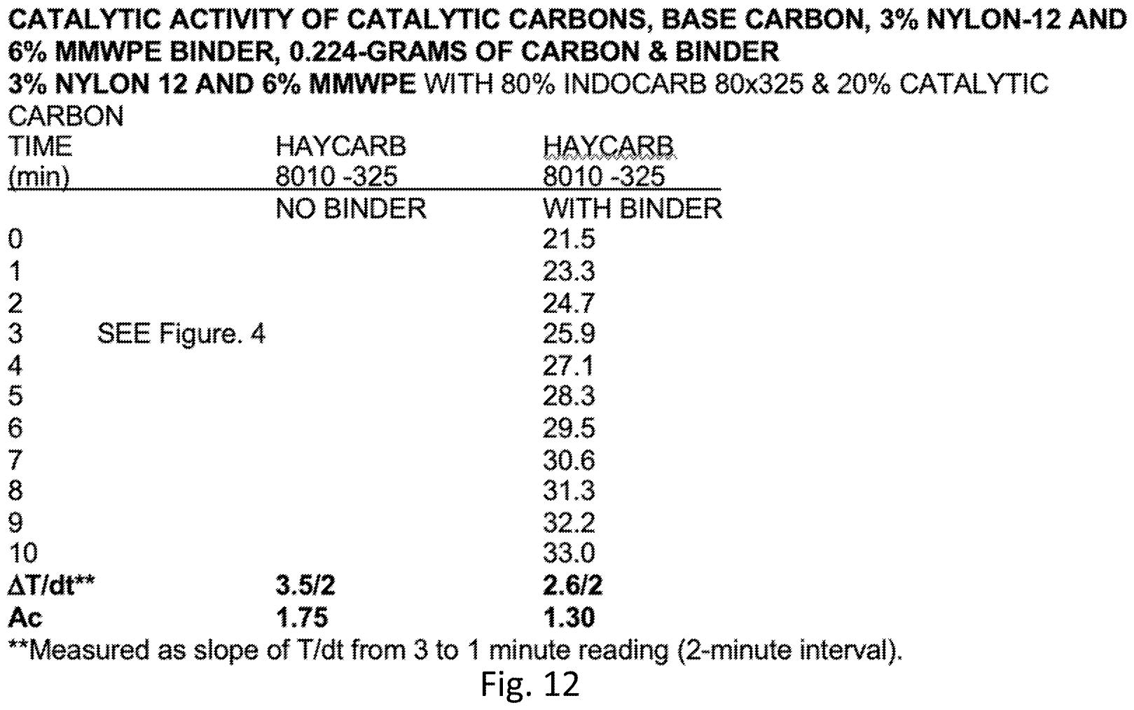

FIGS. 11 and 12 show the catalytic activity of the mixture with a binder, MMWPE. The mix of base carbon and catalytic carbon was blended with the same technique. MMWPE is approximately 33 microns and is, therefore, significantly fewer microns in size than HDPE. Due to the close range in micron size, the MMWPE may be compared to the GUR results in FIG. 5 and FIG. 6.

FIG. 11 provides the result of Catalytic Carbon, Base Carbon, and 14% by weight of the mixture of MMWPE. The carbon block structure bonding formed at 14% by weight concentration was acceptable but not as good as the 14% GUR 2105-1. However, the damage to HayCarb catalytic carbon is 40%, which is superior to GUR 2105-1 at a 48.6% decline in catalytic performance but not acceptable. MMWPE is 33 microns, and GUR 2105-1 is 21 microns, which may account for the apparent difference in carbon block quality. Regardless, using only one of these binders may result in inferior carbon block quality or a decline in catalytic performance.

FIGS. 12, 13, and 14 provide the result of Catalytic Carbon, Base Carbon, and a percent by weight of the mixture of polymer alloy. The use of the first binder varies by percent by weight and is either the MMWPE or the GUR binder. The second ultra-fine binder, Nylon-12, remains the same but is used at different percentages by weight of the mixture.

FIG. 12 provides the result of Catalytic Carbon, Base Carbon, and the first binder of 6% MMWPE and the second binder of Nylon-12 at 3% by weight of the mixture. The carbon block formed using the 3% Nylon-12 and 6% MMWPE was structurally sound and provided a high-quality carbon block. The impact on the performance of HayCarb 1810 catalytic carbon was a 25.7% reduction in performance, which is tolerable.

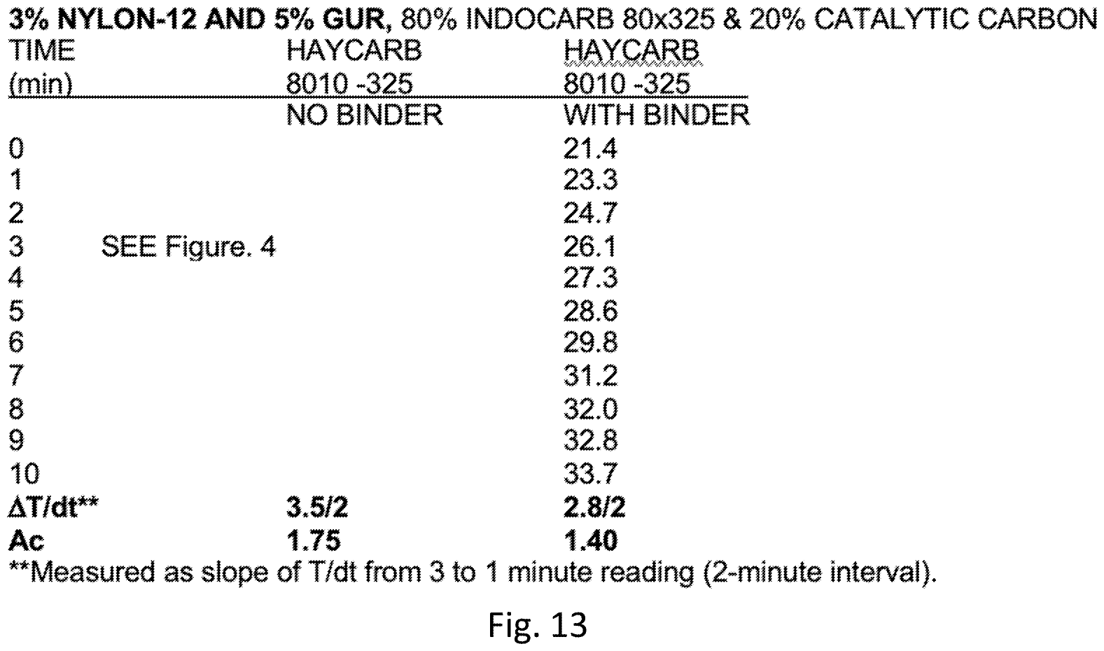

FIG. 13 provides the result of Catalytic Carbon, Base Carbon, 5% GUR 2126, and a second binder Nylon-12 at 3% by weight of the mixture. The mixture resulted in a similar quality Carbon Block as FIG. 12, which is considered high quality. This mixture resulted in a slightly better catalytic activity with a 20% decline in catalytic performance.

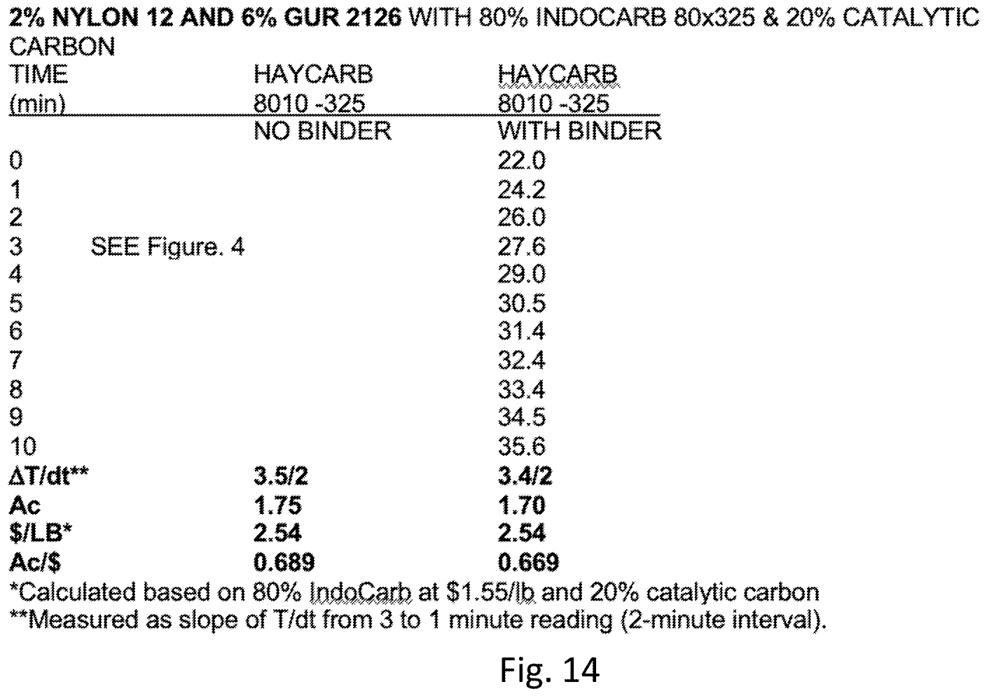

FIG. 14 provides the result of Catalytic Carbon, Base Carbon, and 6% GUR 2126 and a second binder Nylon-12 at 2% by weight of the mixture. The result achieved reasonably good carbon block integrity. This composition of polymer alloy resulted in only a 3% decline in catalytic performance. The use of the polymer alloy produced a demonstrably superior result compared to the previous results, including only one polymer alloy.

While the present teachings have been described above in terms of specific embodiments, it is to be understood that they are not limited to these disclosed embodiments. Many modifications and other embodiments will come to mind for those skilled in the art to which this pertains and are intended to be covered by this disclosure. It is intended that the scope of the present teachings should be determined by proper interpretation and construction of the disclosure and its legal equivalents, as understood by those of skill in the art relying upon the disclosure in this specification and the attached drawings. In describing the invention, it will be understood that several techniques and steps are disclosed. Each of these has individual benefits, and each can also be used in conjunction with one or more, or in some cases all, of the other disclosed techniques. Accordingly, for clarity, this description will refrain from repeating every possible combination of the individual steps in an unnecessary fashion. Nevertheless, the specification should be read with the understanding that such combinations are entirely within the scope of the invention.

1. A carbon structure comprising:
a mixture and a polymer;
wherein the mixture comprises a base carbon and a catalytic carbon;
wherein the polymer comprises a first binder having a median diameter of less than 10 microns and a second binder having a median diameter between 10 and 70 microns.

2. The carbon structure of claim 1, wherein the base carbon composes 75-85% of the mixture by weight, and the catalytic carbon composes 15-25% of the mixture by weight.

3. The carbon structure of claim 2, wherein the base carbon composes 80% of the mixture by weight, and the catalytic carbon composes 20% of the mixture by weight.

4. The carbon structure of claim 1, wherein the first binder by weight is more than the second binder by weight.

5. The carbon structure of claim 4, wherein the first binder is 3-10% by weight of the mixture, and the second binder is 1-6% of the mixture by weight.

6. The carbon structure of claim 4, wherein the first binder is 10-20% of the mixture by weight and the second binder is 6-10% of the mixture by weight.

7. The carbon structure of claim 4, wherein the first binder is 5-8% of the mixture by weight and the second binder is 2-3% of the mixture by weight.

8. The carbon structure of claim 1, wherein the second binder is Nylon-12.

9. The carbon structure of claim 1, wherein the first binder is selected from a group comprising at least one of GUR-2105-1, GUR-2126, MMWPE, and HDPE.

10. The carbon structure of claim 1, wherein the first binder is GUR-2126 and the second binder is Nylon-12.

11. The carbon structure of claim 1, wherein the first binder is MMWPE and the second binder is Nylon-12.

12. The carbon structure of claim 1, wherein the base carbon is Indocarb.

13. The carbon structure of claim 1, wherein the catalytic carbon is selected from a group comprising HayCarb or Kuraray.

14. A carbon structure comprising:
a mixture and a polymer;
wherein the mixture comprises 80% by weight of a base carbon and 20% by weight of a catalytic carbon;
wherein the polymer comprises 5-8% by weight of the mixture of a first binder having a median diameter between 10 and 70 microns and 2-3% by weight of the mixture of a second binder having a median diameter of less than 10 microns;
wherein the base carbon is Indocarb;
wherein the catalytic carbon is HayCarb;
wherein the first binder is GUR-2126;
wherein the second binder is Nylon-12.

15. A method of manufacturing a carbon block and an immobilized powder structure comprising:
blending one or more powder carbons into a mixture;
adding a polymer into the mixture;
wherein the polymer comprises a first binder having a median diameter between 10 and 70 microns and a second binder having a median diameter of less than 10 microns;
heating the mixture until the powder carbons are immobilized;
cooling the mixture into a carbon block.

16. The method of claim 15, wherein the one or more powder carbons comprises at least one powder carbon with enhanced catalytic activity.

17. The method of claim 16, wherein the fouling of the powdered carbon with enhanced catalytic activity is 3-20%.

18. The method of claim 15, wherein the first binder is 5-6% by weight of the at least one powder carbons and the second binder is 2-3% by weight of the at least one powder carbons.
